(19) United States
(12) Patent Application Publication
(10) Pub. No.: US 2024/0413627 A1
(43) Pub. Date: Dec. 12, 2024

(54) Drop Cable Sealing

(71) Applicant: Go!Foton Holdings, Inc., Somerset, NJ (US)

(72) Inventors: Kenichiro Takeuchi, North Brunswick, NJ (US); David Zhi Chen, Dallas, TX (US); Alla Shtabnaya, Hillsborough, NJ (US); Haruki Nakagawa, Milford, NJ (US)

(73) Assignee: Go!Foton Holdings, Inc., Somerset, NJ (US)

(21) Appl. No.: 18/737,036

(22) Filed: Jun. 7, 2024

Related U.S. Application Data
(60) Provisional application No. 63/472,485, filed on Jun. 12, 2023.

(51) Int. Cl. H02G 15/013; H02G 3/06

(52) U.S. Cl. CPC H02G 15/013; H02G 3/0658

(57) ABSTRACT

Cable seals and related technology providing an optimized combination of ease-of-use and component protection when used in multi-cable terminals. When used in a multi-cable terminal, a cable seal of the technology allows for easy access to the interior of the multi-cable terminal when access is necessary, such as when cables need to be connected to the terminal or disconnected from the terminal, while readily sealing the terminal watertight when the seal is secured by the terminal enclosure.

### CROSS-REFERENCE TO RELATED APPLICATIONS

The present application claims the benefit of the filing date of U.S. Provisional Patent Application No. 63/472,485 filed on Jun. 12, 2023, the disclosure of which is hereby incorporated herein by reference.

### BACKGROUND

The increasing deployment of electronic and fiber optic networks has given rise to an increasing need to manage the distribution of signals in such networks. Often, the distribution of signals is managed through the routing of cables associated with the signals and involves the use of multi-cable terminals that allow for selective connection between cables at designated points in a network.

The increasing need to manage signal distribution is particularly acute with respect to fiber optic communications. For example, fiber optic communication signals between individual homes and a fiber network may be implemented through an Outside Plant (OSP) terminal, such as a drop box. In such a system, the terminal may couple a high capacity main cable to a multiple of lower capacity cables so that communication signals for each home may be delivered via the corresponding low capacity dedicated cable. In this manner, there is no need to run a high capacity cable to each home. Moreover, the terminal may be constructed so as to allow cables to be easily connected to the terminal and easily disconnected from the terminal, as dictated by circumstance. For instance, if a home's dedicated cable is damaged the cable may be readily disconnected from the terminal and replaced with a new cable.

### BRIEF SUMMARY

In creating the technology described in this disclosure, it was recognized that a desirable feature of multi-cable terminals is an optimized combination of ease-of-use and component protection. Such optimization is among the advantages of the technology. One of the features of the present technology is a cable seal that may be used in a multi-cable terminal. The cable seal allows for easy access to the interior of a multi-cable terminal when access is necessary, such as when cables need to be connected to the terminal or disconnected from the terminal, while readily sealing the terminal watertight when the seal is secured by the terminal enclosure.

In accordance with an aspect of the technology described in this disclosure, a cable seal includes a base; and an elastic material having a generally arched shape when the elastic material is not in a compressed configuration, and including a plurality of bores extending from a first side of the cable seal to a second side of the cable seal and a plurality of passages extending from the first side of the cable seal to the second side of the cable seal, the passages respectively corresponding to the bores such that for each bore a cable or plug may be inserted into the bore via the corresponding passage, wherein the base is configured to accommodate the clastic material, and wherein the clastic material is configured to be compressed against the base such that when each of the bores contains a cable or plug and the elastic material is compressed a watertight seal is formed between the elastic material and the base, a watertight seal is formed between the clastic material and each cable and/or plug, a watertight seal is formed between the clastic material and an enclosure in which the cable seal is positioned, and the passages are closed watertight.

In accordance with another aspect of the technology described in this disclosure, a cable seal includes a base having a plurality of base grooves extending from a first side of the cable seal to a second side of the cable seal, each base groove being shaped to accommodate a cable or plug; and a cover configured to mate with the base such that, when each base groove is accommodating a cable or plug and the cover is mated with the base a watertight seal is formed between the base and the cover, a watertight seal is formed between the base and each cable and/or plug, and a watertight seal is formed between the cover and each cable and/or plug.

In accordance with still another aspect of the technology described in this disclosure, a cable seal includes an clastic material having a plurality of bores extending from a first side of the cable seal to a second side of the cable seal and a plurality of passages extending from the first side of the cable seal to the second side of the cable seal, the passages respectively corresponding to the bores such that for each bore a cable or plug may be inserted into the bore via the corresponding passage, wherein each bore is configured to have a cross-sectional area that is larger than a cross-sectional area of the corresponding cable or plug when the elastic material is in an uncompressed state, and wherein the elastic material is configured to be compressed against an enclosure in which the cable seal is positioned such that when each bore contains a cable or plug and the elastic material is compressed a watertight seal is formed between the elastic material and each cable and/or plug, a watertight seal is formed between the elastic material and the enclosure, and the passages are closed watertight.

### BRIEF DESCRIPTION OF THE DRAWINGS

The accompanying drawings are not intended to be drawn to seale. Also, for purposes of clarity not every component may be labeled in every drawing.

FIG. 1A is a cross-sectional view of a cable seal of an embodiment.

FIG. 1B is a cross-sectional view of the cable seal of FIG. 1A in a compressed configuration.

FIG. 2 is a cross-sectional view the cable seal of FIGS. 1A and 1B as included in an illustrative enclosure with a mating portion.

FIG. 3 is a perspective view of an illustrative multi-cable terminal including the cable seal of FIGS. 1A and 1B.

FIG. 4 is a perspective view of the multi-cable terminal of FIG. 3 showing internal components of the terminal.

FIG. 5A is a cross-sectional view of a cable seal of an embodiment, with base and cover elements of the cable seal in an unmated position.

FIG. 5B is a side view of the cable seal of FIG. 5A, the side view being a view corresponding to a line of sight along the cross-section of FIG. 5A.

FIG. 5C is a cross-sectional view of a cable seal of an embodiment, with base and cover elements of the cable seal in an unmated position.

FIG. 5D is a side view of the cable seal of FIG. 5C, the side view being a view corresponding to a line of sight along the cross-section of FIG. 5C.

FIG. 6A is a cross-sectional view of a cable seal of an embodiment, with base and cover elements of the cable seal in an unmated position.

FIG. 6B is a side view of the cable seal of FIG. 6A, the side view being a view corresponding to a line of sight along the cross-section of FIG. 6A.

FIG. 6C is a cross-sectional view of a cable seal of an embodiment, with base and cover elements of the cable seal in an unmated position.

FIG. 6D is a side view of the cable seal of FIG. 6C, the side view being a view corresponding to a line of sight along the cross-section of FIG. 6C.

FIG. 7A is a perspective view of a cable seal of an embodiment, with cables positioned in the cable seal.

FIG. 7B is a perspective view of a multi-cable terminal enclosure in which the cable seal of FIG. 7A may be employed.

FIG. 8 is a perspective view of the cable seal of FIG. 7A as employed in the enclosure of FIG. 7B.

FIGS. 9A-9D are cross-sectional depictions of a considered cable seal arrangement, and are provided for reference in illustrating some advantages of the presently disclosed technology.

FIG. 10A is a perspective view a cable seal of an embodiment, with feeder cables positioned in the cable seal.

FIG. 10B is a perspective view of the cable seal of FIG. 10A positioned within an enclosure, with feeder cables and service cables positioned in the cable seal.

FIG. 11A is a perspective view of a multi-cable terminal enclosure lid, showing how clamping levers may be rotatably and removably attached to the lid.

FIG. 11B is a perspective view of a multi-cable terminal including the lid and clamping levers of FIG. 11A.

FIG. 11C is a front side view of the multi-cable terminal of FIG. 11B.

FIG. 12A is a perspective view of the multi-cable terminal of FIGS. 11B and 11C with the lid removed and showing a drop cable tray of the multi-cable terminal in a secured position.

FIG. 12B is a perspective view of the configuration of FIG. 12A with the drop cable tray in a raised position.

FIG. 12C is a perspective view of the configuration of FIG. 12B with the drop cable tray in an open position.

FIG. 12D is a perspective view of a drop cable tray connection part of the configuration of FIG. 12C.

FIG. 13A is a perspective view of an enclosure base and splice tray arrangement of the multi-cable terminal of FIGS. 11B-12C.

FIG. 13B is a perspective the splice tray arrangement the FIG. 13A configuration.

FIG. 13C is a perspective view of the FIG. 13A configuration, with an upper splice tray in a raised position.

FIG. 13D is a perspective view of the FIG. 13A configuration, with both an upper splice tray and a lower splice tray in raised positions.

FIG. 14A is a perspective view of a feeder cable arrangement for the multi-cable terminal of FIGS. 11B-12C.

FIG. 14B is a side view of the feeder cable arrangement of FIG. 14A.

### DETAILED DESCRIPTION

Examples of systems and methods are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

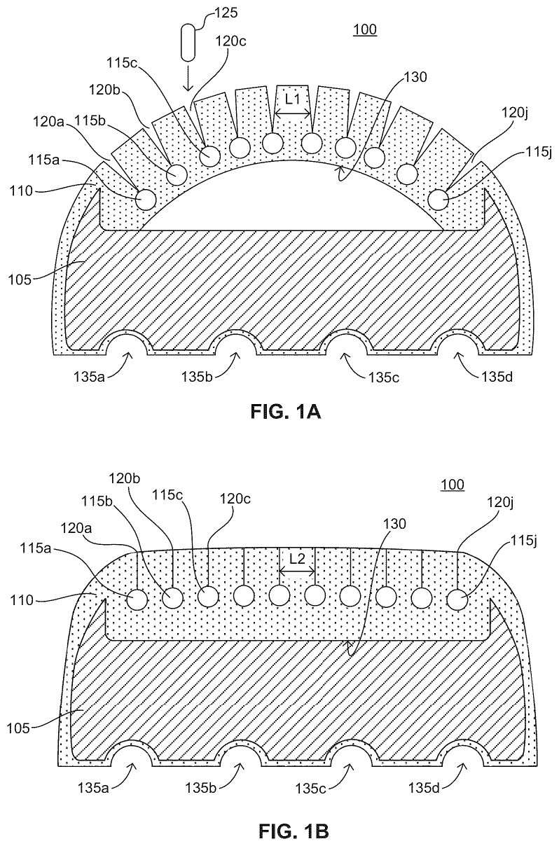

FIG. 1A is a cross-sectional view of a cable seal 100 of an embodiment. The cable seal includes a base 105 and an elastic material 110. The clastic material 110 has a multiple of bores 115a-115j, collectively 115, that each extend through the elastic material 110 from a first side of the cable seal 100 to a second side of the cable seal 100, i.e., in a direction perpendicular to the cross section of the figure. The elastic material also has a multiple of passages 120a-120j, collectively 120, the passages 120 likewise extending through the elastic material 110 from a first side of the cable seal 100 to a second side of the cable seal 100. The passages 120 respectively correspond to the bores 115 and allow access to the bores 115 so that, for each bore 115 a cable may be inserted in the bore 115 or removed from the bore 115 via the corresponding passage 120. For example, as shown in FIG. 1A, a cable 125 (shown in cross-section) may be inserted in bore 115c via passage 120c. In this manner, cables may be readily inserted and removed from bores 115 in the cable seal 100 as part of operations on a multi-cable terminal of which the cable seal 100 is a part. Further, for each bore 115 that is not used to accommodate a cable, a plug may be inserted in the bore so that none of the bores 115 provide a path for water or other elements to pass through the cable seal 100

Notably, the cable seal 100 as depicted in FIG. 1A is in a state amenable to accessing cables or plugs positioned in the bores 115. Such state is referred to as an uncompressed state of the cable seal 100. As can be seen from FIG. 1A, in the uncompressed state the cable seal 100 may have a generally arched shape, the cable seal 100 has an underside portion 130 that is separated from the base 105, and the passages 120 may be in a spread open state. Further, in FIG. 1A an arbitrary cross-sectional dimension between two adjacent passages 120 is denoted by L1. L1 will be referenced for comparison purposes in connection with FIG. 1B.

FIG. 1B is a cross-sectional view of the cable seal 100 of FIG. 1A in a compressed state. The compression of the cable seal 100 is reflected in FIG. 1B by a cross-sectional dimension L2, which positionally corresponds to cross-sectional dimension L1 of FIG. 1A but is smaller than L1 due to the compression. As can be seen from FIG. 1B, in the compressed state the generally arched shape of the cable seal 100 is changed to a generally linear shape, the passages 120 take the form of closed slits, and the underside portion 130 contacts the base 105. The closed slits are watertight, and the contact between the underside portion 130 and the base 105 is watertight. In addition, in the compressed state, when there is a cable or plug in each of the bores 120 the contact between each bore and the corresponding cable or plug is watertight. In this manner, when the cable seal 100 has a cable or plug in each bore 115, is in the compressed state, and is appropriately enclosed, the cable seal provides a watertight seal between the first side of the cable seal and the second side of the cable seal.

As can be further seen from FIGS. 1A and 1B, the cable seal 100 may include main cable grooves 135a-135d, collectively 135. The main cable grooves 135 are provided to accommodate main cables, such as feeder cables or branch cables, extending between the first side of the cable seal 100 and the second side of the cable seal. As shown in FIGS. 1A and 1B, the main cable grooves 135 may be positioned under the elastic material 110, which surrounds the base 105. However, it should be noted that the main cable grooves 135 do not need to be positioned under the clastic material 110, and that the elastic material 110 does not need to surround the base 105.

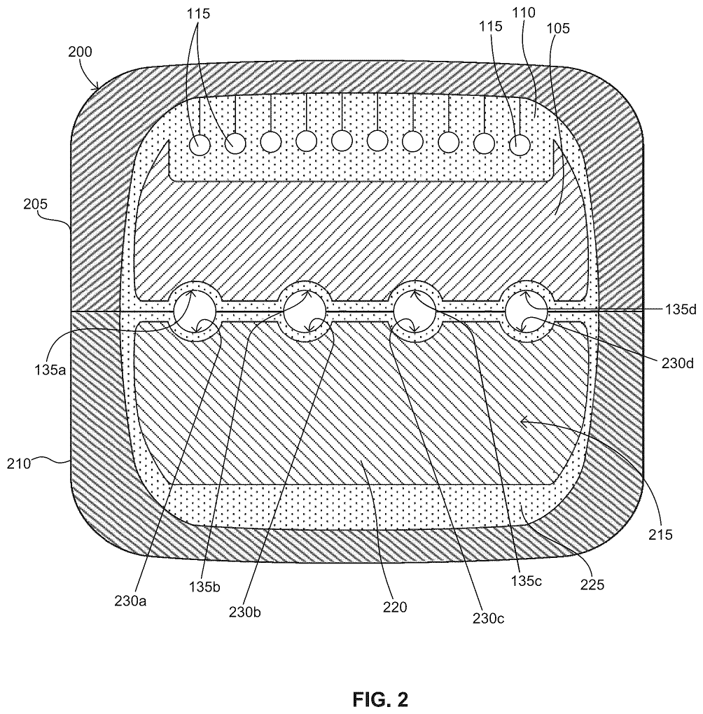

Turning now to FIG. 2, the figure is a cross-sectional view the cable seal 100 of FIGS. 1A and 1B as included in an illustrative enclosure 200 having an enclosure lid 205 and an enclosure base 210. The enclosure lid 205 acts to compress the elastic material 110 when the enclosure lid 205 is secured to the enclosure base 210. Thereby, when there is a cable or plug in each of bores 115 and the enclosure lid 205 is secured to the enclosure based 210, a watertight seal is provided between the first side of the cable seal 100 and the second side of the cable seal 100. Moreover, securing the enclosure lid 205 to the enclosure base 210 also provides a watertight seal between the cable seal and the enclosure lid 205.

Also shown in FIG. 2 is a mating portion 215 structured to mate with the cable seal 100. The mating portion 215 may include a mating base 220, which may be surrounded by a mating elastic material 225. The mating base 220 may be made of the same material as the base 105 of the cable seal 100, and the mating elastic material 225 may be made of the same material as the elastic material 110 of the cable seal 100, although the materials of the mating base 220 and the mating clastic material 225 are not restricted to matching the materials used in the cable seal 100. In any event, the mating portion 215 may include mating main cable grooves 230a-230d, collectively 230. The mating main cable grooves 230 are arranged to respectively correspond to main cable grooves 135 such that when a main cable or plug is positioned in each of the mating main cable grooves 230, the mating portion 215 is mated with the cable seal 100, and the mated mating portion 215 and cable seal 100 are compressed within enclosure 200, the cable seal 100 and mating portion 215 form a watertight seal about the main cable(s) and/or plug(s). Further when the mating portion 215 is mated with the cable seal 100, and the mated mating portion 215 and cable seal 100 are compressed within enclosure 200, a watertight seal is formed between the mating portion 215 and the enclosure base 210.

In the FIG. 2 configuration, the enclosure 200, cable seal 100, and mating portion 215 may be parts of a multi-cable terminal. Accordingly, the enclosure 200, cable seal 100, and mating portion 215 may provide a watertight seal between the interior of such main cable terminal and the exterior of such main cable terminal. More specifically, when a cable or plug is positioned in each of bores 115, a cable or plug is inserted in each of main cable grooves 135 and mating main cable grooves 230, and the enclosure lid 205 is secured to the enclosure base 210, watertight seals are formed around each of the cables and/or plugs, a watertight seal is formed between the cable seal 100 and mating portion 215, a watertight seal is formed between the cable seal 100 and the enclosure lid 205, and a watertight seal is formed between the mating portion 215 and the enclosure base 210. As an option, the mating portion 215 may be attached to the enclosure base 210 in a watertight manner prior to securing the enclosure lid 205 to the enclosure base 210 so that securing the enclosure lid 205 to the enclosure base 210 is not necessary for forming a watertight between the mating portion 215 and the enclosure base 210.

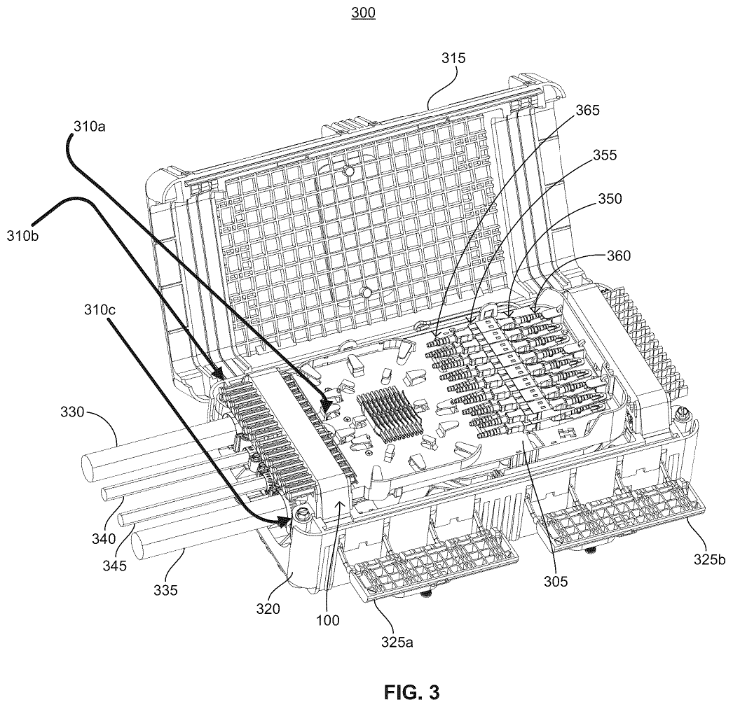

FIG. 3 is a perspective view of an illustrative multi-cable terminal 300 including the cable seal 100 of FIGS. 1A and 1B. As can be seen from the FIG. 3, the cable seal 100 is attached to, or integral with, a drop cable tray 305. The drop cable tray 305 is, in turn, secured within the multi-cable terminal 300 by, for example, using three screws 310a-310c. The multi-cable terminal 300 includes an enclosure lid 315 and an enclosure base 320, the enclosure base 320 being equipped with clamping levers 325a and 325b for securing the enclosure lid 315 to the enclosure base 320. When the enclosure lid 315 is secured to the enclosure base 320 while there are cables and/or plugs in each of the bores 115 of the cable seal 100, a watertight seal is formed about the cables and/or plugs. Also shown in FIG. 3 are an input feeder cable 330, an output feeder cable 335, a first branch cable 340, a second branch cable 345, a multiple of internal cable ports 350 for accommodating respective internal cable connection terminals 360, and a multiple of service cable ports 355 for accommodating respective service cable terminals 365. By way of illustration, each of the internal cable ports 350 may be integral with a corresponding one of the service cable ports 355 in the form of an adapter.

The cables 330-345 are an example of main cables that may be connected to the multi-cable terminal 300. The cables 330-345 may each include one or more internal cables (not shown) which may be selectively accessed via splicing within the multi-cable terminal 300. Selected ones of the spliced cables may be communicatively coupled to respective ones of the service cables, through a corresponding set of elements including one each of the internal cable connection terminals 360, the internal cable ports 350, the service cable ports 355, and the service cable connection terminals 365.

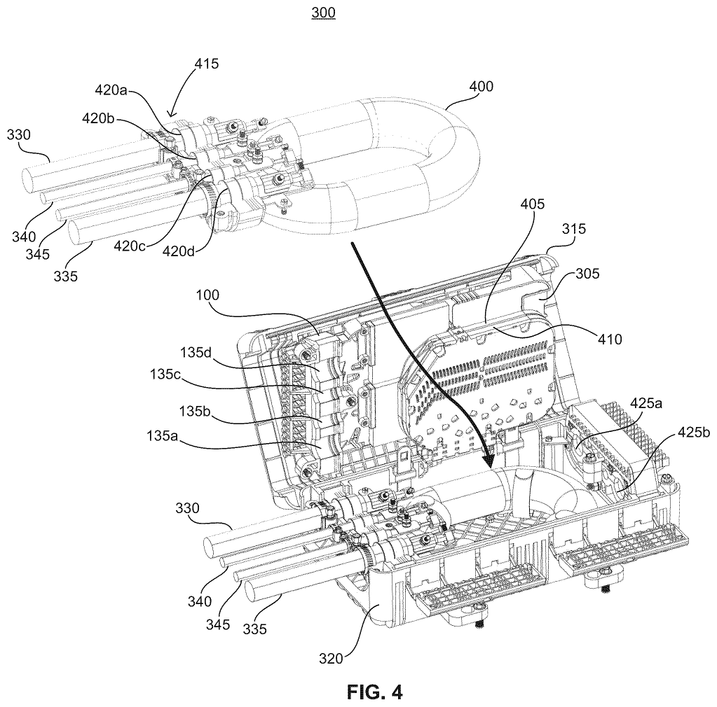

Referring now to FIG. 4, the figure is a perspective view of the multi-cable terminal 300 of FIG. 3 showing internal components of the terminal 300. As can be seen from FIG. 4, the multi-cable terminal may include a buffer tube 400, an upper splice tray 405, and a lower splice tray 410. The buffer tube 400 may be used to store cables stemming from one or more of input feeder cable 330, output feeder cable 335, first branch cable 340, and second branch cable 345. Further, cables stored in the buffer tube may be routed to one or both of the splice trays 405 and 410 for splicing to one or more internal cables (not shown) or to one or more of the cables 330-345. In addition, it is noted that the multi-cable terminal 300 includes in-line cable openings 425a and 425b to allow use of the multi-cable terminal 300 in an in-line configuration.

As can be further seen from FIG. 4, the main cable terminal 300 includes a mating portion 415 for mating with cable seal 100. The mating portion 415, in contrast to the mating portion 215 of FIG. 2, does not include mating main cable grooves. Rather, the mating portion 415 includes main cable bores 420a-420d. The main cable bores 420a-420d respectively secure input feeder cable 330, first branch cable 340, second branch cable 345, and output feeder cable 335 to the mating portion 415, and respectively mate with main cable grooves 135a-135d of the cable seal 100 such that when cables 330-345 are positioned in main cable bores 420a-420d and the mating portion 415 and the cable seal 100 are compressed in a mating position, a watertight seal is formed about each of cables 330-345.

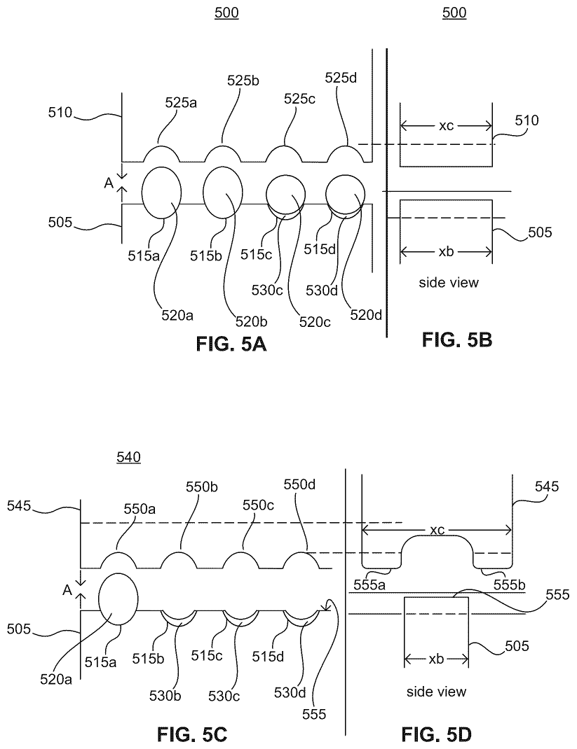

Turning now to FIG. 5A, the figure shows a cross-sectional view of a cable seal 500 of an embodiment. The cable seal 500 includes a base 505 and a cover 510, and FIG. 5A shows the base 505 and cover 510 in an unmated position. To mate the base 505 to the cover 510, the base 505 and cover are moved toward each other as shown by arrows A. In any event, the base 505 includes a multiple of base grooves 515a-515d extending from a first side of the cable seal 500 to a second side of the cable seal 500, each of base grooves 515a-515d being shaped to accommodate a cable or plug. In FIG. 5A, the base grooves 515a-515d are show with cables 520a-520 respectively positioned in the grooves 515a-515d. The cover 510 includes a multiple of cover grooves 525a-525d extending from the first side of the cable seal 500 to the second side of the cable seal 500, and is configured to mate with the base 505 such that the cover grooves 525a-525d align with respective ones of the base grooves 515a-515d. Moreover, the cover 510 is configured to mate with the base 505 such that, when each of the base grooves 515a-515d is accommodating a cable or plug and the cover 510 is mated with the base 505 a watertight seal is formed between the base 505 and the cover 510, a watertight seal is formed between the base 505 and each cable and/or plug (e.g., cables 520a-520d), and a watertight seal is formed between the cover 510 and each cable and/or plug (e.g., cables 520a-520d).

It is noted that each of the base grooves 515a-515d may include a removable section. In FIG. 5A, removable sections 530c and 530d are shown as examples of removable sections that have not been removed from their respective base grooves 515c and 515d. As illustrated in FIG. 5A, a base groove with an unremoved removable section may have a cross-sectional shape that is different from that of a base groove with a removed removable section. For example, the cross-sectional shape of a base groove 515c may be semicircular, while the cross-sectional shape of base groove 515a may be semioval, and thus groove 515c may be suited to accommodate a circular cable, e.g., cable 5205c and groove 515a may be suited to accommodate an oval cable, e.g., cable 520a.

It should be further noted that removable sections 530c and 530d may be formed as elastically collapsible sections that may remain in place within the base grooves 515c and 515d while still accommodating cables of different sizes. For example, removable sections 530c and 530d may include multiple spaced fins that are movable so that the grooves 515c and 515d can accommodate cables of different sizes while the removable section 530c and 530d are still in the base grooves 515c and 515d. As another example, removable sections 530c and 530d may be made of a material that is softer than the base 505 and/or the cover 510 so as to facilitate deformation of the removable sections 530c and 530d to accommodate cables of different sizes while the removable section 530c and 530d are still in the base grooves 515c and 515d.

It is additionally noted that the base 505 and cover 510 of cable seal 100 may have the same hardness or different hardness. For instance, the base 505 and cover 510 may have a Shore hardness of A20; or the base 505 may have a Shore hardness of A20, while the cover 510 may have a Shore hardness on the 00 level.

FIG. 5B is a side view of the cable seal 500 of FIG. 5A, the side view being a view corresponding to a line of sight along the cross-section of FIG. 5A. As can be seen from FIG. 5A, the base 505 of cable seal 500 has a base width dimension Xb extending from the first side of the cable seal 500 to the second side of the cable seal 500, and the cover 510 of cable seal 500 has a cover width dimension Xc extending from the first side of the cable seal to the second side of the cable seal, and the base width dimension Xb is the same as the cover width dimension Xc.

FIG. 5C is a cross-sectional view of a cable seal 540 of an embodiment. The cable seal 540 is similar to the cable seal 500 of FIG. 5A with the exception that cable seal 540 has a different cover, cover 545. The cover 545 has a multiple of cover grooves 550a-550d that extend from a first side of the cable seal 540 to a second side of the cable seal 540, and is configured to mate with the base 505 such that the cover grooves 550a-550d align with respective ones of the base grooves 515a-515d. The cover grooves 550-550d are discontinuous. The discontinuous form of grooves 550a-550d is shown in FIG. 5D.

FIG. 5D is a side view of the cable seal of FIG. 5C, the side view being a view corresponding to a line of sight along the cross-section of FIG. 5C. As can be seen from FIG. 5D, the base 505 of cable seal 540 has a base width dimension Xb extending from the first side of the cable seal 540 to the second side of the cable seal 540, and the cover 545 of cable seal 540 has a cover width dimension Xc extending from the first side of the cable seal to the second side of the cable seal, and the base width dimension Xb is smaller than the cover width dimension Xc. Further, the cover 545 includes a first flange 555a and a second flange 555b, separated by a distance Xb. When the cover 545 is mated with the base 505, as indicated by arrows A, the flanges 555a and 555b extend past a top side 555 of the base 505. Notably, the cover grooves 550a-550d extend only through the flanges 555a and 555b of the cover 545.

The cover 545 is configured to mate with the base 505 such that, when each of the base grooves 515a-515d is accommodating a cable or plug and the cover 545 is mated with the base 505 a watertight seal is formed between the base 505 and the cover 545, a watertight seal is formed between the base 505 and each cable and/or plug (e.g., cable 520a), and a watertight seal is formed between the cover 545 and each cable and/or plug (e.g., cable 520a).

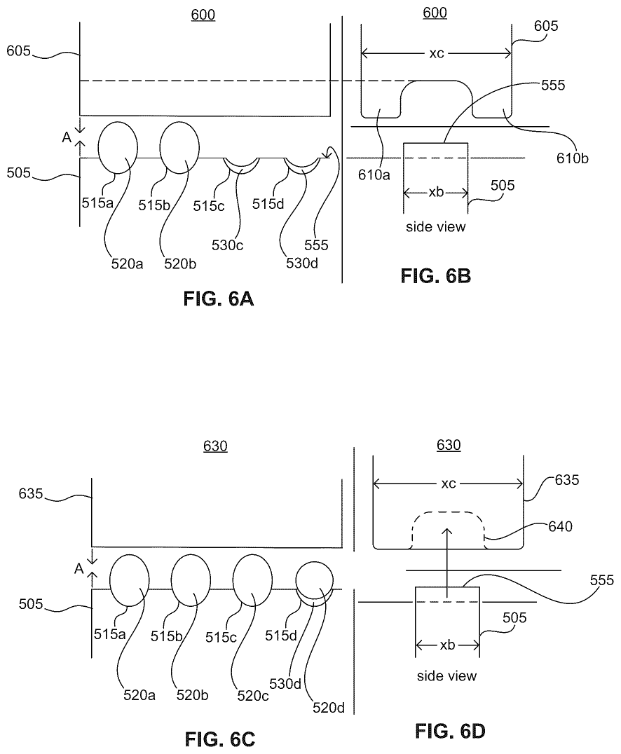

FIG. 6A is a cross-sectional view of a cable seal 600 of an embodiment. The cable seal 600 is similar to the cable seal 500 of FIG. 5A with the exception that cable seal 600 has a different cover, cover 605. The cover 605 has no cover grooves, but has flanges, which are described in connection with FIG. 6B.

FIG. 6B is a side view of the cable seal 600 of FIG. 6A, the side view being a view corresponding to a line of sight along the cross-section of FIG. 6A. As can be seen from FIG. 6B, the base 505 of cable seal 600 has a base width dimension Xb extending from a first side of the cable seal 600 to a second side of the cable seal 600, and the cover 605 of cable seal 600 has a cover width dimension Xc extending from the first side of the cable seal 600 to the second side of the cable seal 600, and the base width dimension Xb is smaller than the cover width dimension Xc. Further, the cover 605 includes a first flange 610a and a second flange 610b, separated by a distance Xb. When the cover 605 is mated with the base 505, as indicated by arrows A, the flanges 610a and 610b extend past a top side 555 of the base 505.

The cover 605 is configured to mate with the base 505 such that, when each of the base grooves 515a-515d is accommodating a cable or plug and the cover 605 is mated with the base 505 a watertight seal is formed between the base 505 and the cover 605, a watertight seal is formed between the base 505 and each cable and/or plug (e.g., cables 520a and 520b), and a watertight seal is formed between the cover 605 and each cable and/or plug (e.g., cable 520a and 520b).

FIG. 6C is a cross-sectional view of a cable seal 630 of an embodiment. The cable seal 630 is similar to the cable seal 500 of FIG. 5A with the exception that cable seal 630 has a different cover, cover 635. The cover 635 has no cover grooves and no flanges.

FIG. 6D is a side view of the cable seal 630 of FIG. 6C, the side view being a view corresponding to a line of sight along the cross-section of FIG. 6C. As can be seen from FIG. 6D, the base 505 of cable seal 630 has a base width dimension Xb extending from a first side of the cable seal 630 to a second side of the cable seal 630, and the cover 635 of cable seal 630 has a cover width dimension Xc extending from the first side of the cable seal 630 to the second side of the cable seal 630, and the base width dimension Xb is smaller than the cover width dimension Xc. Further, the cover 635 is deformable such that when the cover 635 is mated with the base 505, as indicated by arrows A, the cover 635 deforms to accommodate the base 505 and to accommodate cables and/or plugs inserted in the base grooves 515a-515d. The accommodated deformity is represented in FIG. 6D by dashed line 640.

The cover 635 is configured to mate with the base 505 such that, when each of the base grooves 515a-515d is accommodating a cable or plug and the cover 635 is mated with the base 505 a watertight seal is formed between the base 505 and the cover 635, a watertight seal is formed between the base 505 and each cable and/or plug (e.g., cables 520a-520c), and a watertight seal is formed between the cover 635 and each cable and/or plug (e.g., cables 520a-520c).

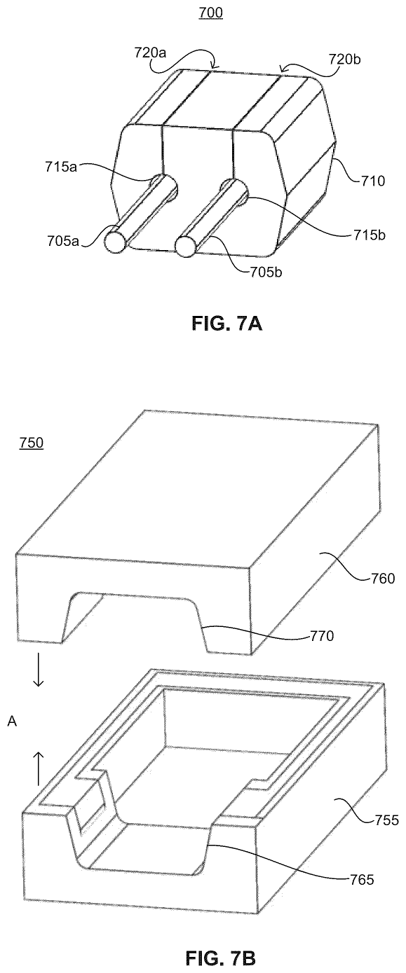

Turning now to FIG. 7A, the figure shows a perspective view of a cable seal 700 of an embodiment, with a first cable 705a and a second cable 705b positioned in the cable seal 700. The cable seal 700 is formed of an elastic material 710, and includes a multiple of bores extending from a first side of the cable seal 700 to a second side of the cable seal 700. For purposes of illustration, FIG. 7A shows the cable seal 700 having two bores, 715a and 715b, although any number of bores may be included in embodiments consistent with FIG. 7A. In any event, the elastic material 710 also includes a multiple of passages, illustrated by passages 720a and 720b, extending from the first side of the cable seal 700 to the second side of the cable seal 700. The passages 720a and 720b respectively correspond to the bores 715a and 715b such that for each of the bores 715a and 715b a cable or plug may be inserted into the bore via the corresponding passage (e.g., cables 705a and 705b). For instance, passage 720a may be spread open by grasping opposing portions of the elastic material 710 about the passage 720a and manipulating the portions to open the passage 720a. Once a cable or plug is inserted into each of the of the bores 715a and 715b, and the clastic material 710 is compressed (e.g., by an enclosure) a watertight seal is formed between the elastic material 710 and each cable and/or plug (e.g., cables 705a and 705b) and the passages (e.g., passages 720a and 720b) are closed watertight.

Notably, each of the bores 715a and 715b has a cross-sectional area that is larger than a cross-sectional area of the corresponding cable or plug (e.g., respectively cables 705a and 705b) when the clastic material 710 is in an uncompressed state. In this manner, the compressed-state sealing between the elastic material 710 and the cables and/or plugs (e.g., cables 705a and 705b) is maximized as stretching of elastic material 710 proximate the cables and/or plugs is minimized.

FIG. 7B is a perspective view of a multi-cable terminal enclosure 750 in which the cable seal 700 of FIG. 7A may be employed. As can be seen from FIG. 7B, the enclosure 750 may include an enclosure base 755 and an enclosure lid 760, which may be matted to each other, as indicated by arrows A. The enclosure base 755 includes a first contoured portion 765, and the enclosure lid 760 includes a second contoured portion 770. The contoured portions 765 and 770 are provided to accommodate the cable seal 700.

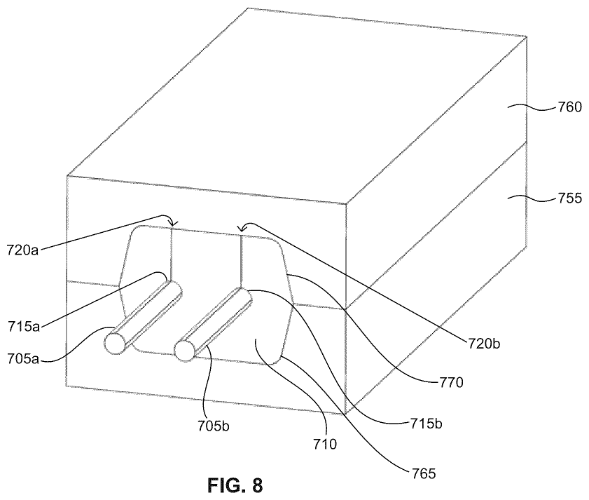

FIG. 8 is a perspective view of the cable seal 700 of FIG. 7A as employed in the enclosure of FIG. 7B 750. As can be seen from FIG. 8, when the elastic material 710 is positioned in the first contoured portion 765 and the second contoured portion 770, and the enclosure lid 760 is secured to the enclosure base 755, the cable seal 700 is compressed by the enclosure lid 760 and the enclosure base 755. Further, when each of the bores of the cable seal 700 (e.g., bores 715a and 715b) contains a cable or plug (e.g., cables 705a and 705b) and the clastic material 710 is compressed by the enclosure base 755 and the enclosure lid 760, a watertight seal is formed between the elastic material 710 and each cable and/or plug (e.g., cables 705a and 705b), a watertight seal is formed between the elastic material 710 and the enclosure base 755, a watertight seal is formed between the elastic material 710 and the enclosure lid 760, and the passages (e.g., passages 720a and 720b) are closed watertight.

Having described the cable seal 700 and an example of its use, a description of some of the advantages of the bore configuration of the cable seal 700 is now provided

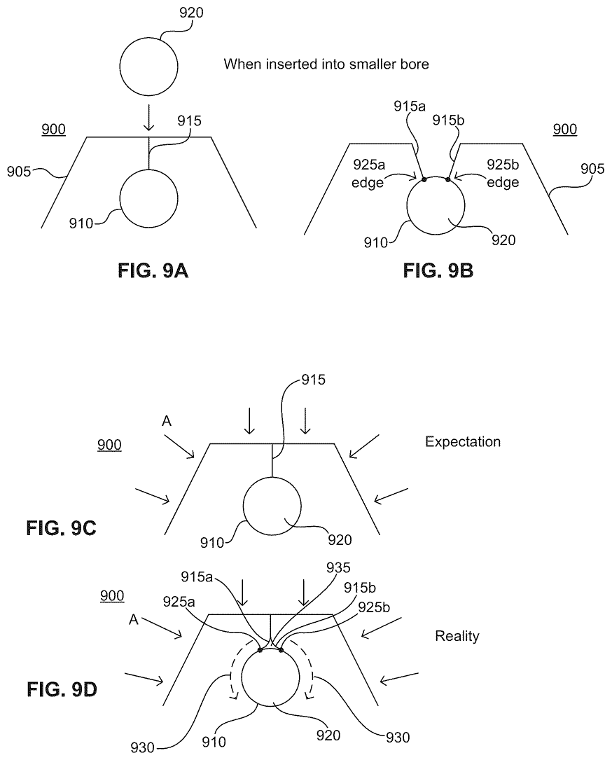

FIGS. 9A-9D are cross-sectional depictions of a considered cable seal arrangement 900. FIGS. 9A-9D are provided for reference in illustrating some advantages of the presently disclosed technology. The arrangement 900 of FIGS. 9A-9D, includes an elastic material 905 having a bore 910 and a passage 915. FIG. 9A shows the arrangement 900 and a cable 920 that is to be inserted into the bore 910. The cable 920 has a cross-sectional area that is equal to or larger than a cross-sectional area of the bore 910. As shown in FIG. 9B, portions of the elastic material 905 may be moved so as to spread apart passage sides 915a and 915b of passage 915 and thereby allow the cable 920 to be passed into the bore 910. As further shown in FIG. 9B, when the cable 920 is inserted into the bore 910, contact between the cable 920 and the passage sides 915a and 915b defines respective contact edges 925a and 925b.

FIG. 9C shows an expected configuration of the cable seal arrangement 900 when the cable 920 has been inserted into the bore 910 and the elastic material 905 has been moved to reclose the passage 915. Reclosure of the passage is depicted by arrows A. As can be seen from FIG. 9C, the common expectation is that the passage sides 915a and 915b will fully mate with each other and the elastic material 905 will contact the cable 920 such that a continuous seal is formed between the clastic material 905 and the cable 920 along the bore 910. However, the expected configuration of FIG. 9C is not realized. FIG. 9D shows, the actual configuration of the cable seal arrangement 900 when the cable is inserted into the bore 910 and the elastic material 905 has been moved to reclose the passage 915. As can be seen from FIG. 9D, when the elastic material 905 is moved to reclose the passage 915, the contact edges 925a and 925b of respective passage sides 915a and 915b encounter frictional resistance 930 along the cable 920. As a result, a gap 935 remains between the elastic material 905 and the cable 920 after the clastic material 905 has been moved to reclose the passage 915. Thus, in reality, when the cable 920, having a cross-sectional area that is equal to or larger than a cross-sectional area of the bore 910, is positioned in the bore 910, there is no continuous seal (e.g., a watertight seal) between the clastic material 905 and the cable 920. The presently disclosed technology overcomes the drawbacks illustrated in FIGS. 9A-9D by employing bores having cross-sectional areas that are larger than the cross-sectional areas of the respective corresponding cables or plugs (e.g., as illustrated in connection with the embodiments of FIGS. 7A-8). In this manner, the presently disclosed technology facilitates the provision of environmental sealing for cable terminals.

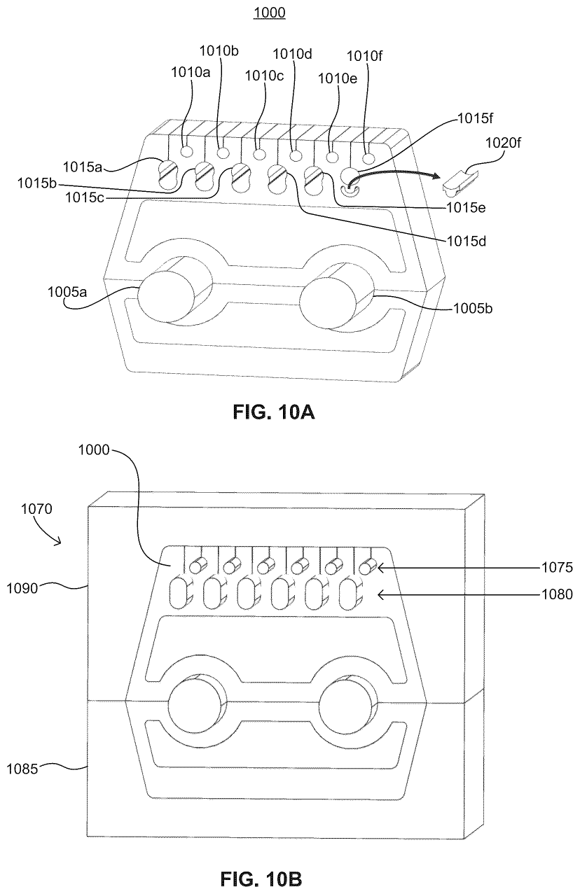

FIG. 10A is a perspective view a cable seal 1000 of an embodiment. The cable seal 1000 is shown with an input feeder cable 1005a and an output feeder cable 1005b inserted in the cable seal 1000. The cable seal 1000 includes a multiple of first bores 1010a-1010f (collectively 1010) and a multiple of second bores 1015a-1015f (collectively 1015), with the first bores 1010 having a cross-sectional dimension that is smaller than a cross-sectional dimension of the second bores 1015. Further, the second bores 1015 may include removable sections, and in this regard, second bores 1015a-1015e are shown with removable sections removed while second bore 1015f is shown with a removable section 1020f in place. FIG. 10A also shows how the removable section 1020f appears when removed. As can be further seen from FIG. 10A, the cable seal 1000 may include one or more arch portions associated with respective ones of the second bores 1015a-1015f. One such arch portion is illustrated in FIG. 10A proximate second bore 1015f. The illustrated arch portion is provided so as to allow for easy removal of the removable section 1020f from second bore 1015f. However, when the removable section 1020f is positioned in the second bore 1015f and a cable is inserted into the second bore 1015f, the arch portion may be compressed to closure to ensure that water or other material does not leak through the arch portion from a first side of the cable seal 1000 to a second side of the cable seal 1000. Nevertheless, to ensure that material does not leak through the arch portion in the event that the removable section 1020f is not sufficiently compressed, the arch portion may be formed such that it does not extend all the way from the first side of the cable seal 1000 to the second side of the cable seal 1000. That is, the arch portion may extend only part of the way from the from the first side of the cable seal 1000 to the second side of the cable seal 1000. In this manner, material cannot leak from the first side of the cable seal 1000 to the second side of the cable seal 1000 even when insertion of a cable into the second bore 1015f does not effect sealing closure of the arch portion.

FIG. 10B is a perspective view of the cable seal 1000 of FIG. 10A positioned within an enclosure 1070. In FIG. 10B, the cable seal 1000 is shown with service cables 1075 and 1080 respectively inserted in bores 1010 and 1015. The enclosure 1070 has an enclosure base 1085 and an enclosure lid 1090.

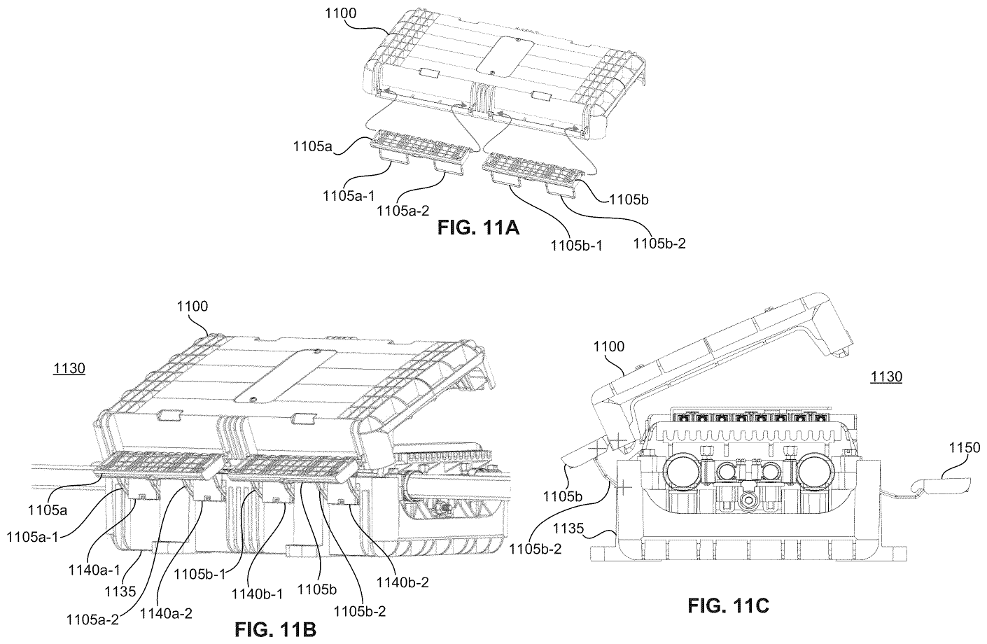

FIG. 11A is a perspective view of a multi-cable terminal enclosure lid 1100, showing how clamping levers 1105a and 1105b may be rotatably and removably attached to the lid 1100. The lid 1100 may be used, for example, as the lid for the multi-cable terminal 300 depicted in FIGS. 3 and 4. As can be seen from FIG. 11A, the clamping lever 1105a may include latches 1105a-1 and 1105a-2, and the clamping lever 1105b may include latches 1105b-1 and 1105b-2. The latches 1105a-1 to 1105b-2 may mate with respective catches of a multi-cable terminal.

FIG. 11B is a perspective view of a multi-cable terminal 1130 including the enclosure lid 1100 and clamping levers 1105a and 1105b of FIG. 11A. The multi-cable terminal 1130 includes an enclosure base 1135. As shown, the enclosure base 1135 may include catches 1140a-1, 1140a-2, 1140b-1 and 1140b-2. In FIG. 11B, the catches 1140a-1 to 1140b-2 are shown as respectively engaged with latches 1105a-1 to 1105b-2. When the 1105a-1 to 1105b-2 are engaged with catches 1140a-1 to 1140b-2, the clamping levers 1105a and 1105b may be used to secure the enclosure lid 1100 to the enclosure base 1135.

FIG. 11C is a front side view of the multi-cable terminal 1130 of FIG. 11B. As can be seen from FIG. 11C, one or more additional clamping levers, e.g., clamping lever 1150, may be used with clamping levers 1105a and 1105b to secure the enclosure lid 1100 to the enclosure base 1135. By way of example, the clamping lever 1150 may take the same form as clamping lever 1105a or clamping lever 1105b and may be positioned at a side of the multi-cable terminal 1130 that is opposite a side of the multi-cable terminal 1130 where clamping levers 1105a and 1105b are positioned.

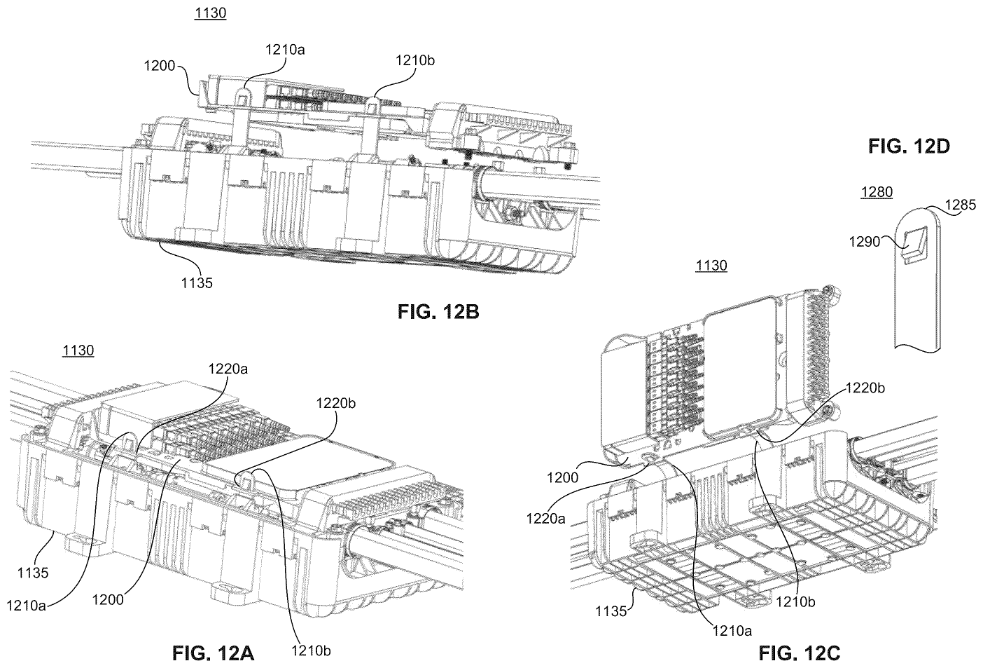

FIG. 12A is a perspective view of the multi-cable terminal 1130 of FIGS. 11B and 11C with the enclosure lid 1100 removed and showing a drop cable tray 1200 of the multi-cable terminal 1130 in a secured position. As can be seen from FIG. 12A, the multi-cable terminal 1130 may include drop cable tray connection parts 1210a and 1210b for movably coupling the enclosure lid 1100 to the enclosure base 1135. The connection parts 1210a and 1210b may couple to the drop cable tray 1200 through respective tray slots 1220a and 1220b in the drop cable tray 1200; and may couple to the enclosure base 135 through respective base slots (not shown). The base slots allow for sliding movement of the connection parts 1210a and 1210b within the base slots.

FIG. 12B is a perspective view of the configuration of FIG. 12A with the drop cable tray 1200 in a raised position. As can be seen from FIG. 12B, the connection parts 1210a and 1210b have been slid upward within their respective base slots to allow the drop cable tray 1200 to be raised relative to the enclosure base 1135.

FIG. 12C is a perspective view of the configuration of FIG. 12B with the drop cable tray 1200 in an open position. As can be seen from FIG. 12C, the connection parts 1210a and 1210b have been curved relative to their form in FIGS. 12A and 12B (e.g., their “original form”) to allow the drop cable tray 1200 to be rotated relative to its position in FIGS. 12A and 12B.

FIG. 12D is a perspective view of a drop cable tray connection part 1280 that is representative of an embodiment of the drop cable tray connection parts 1210a and 1210b of FIGS. 12A-12C. The connection part 1280 may be made of an elastic material so that it may bend in the manner depicted in FIG. 12C. Further the connection part 1280 may include a curved edge 1285 to facilitate insertion in a tray slot, such as tray slot 1220a or tray slot 1220b. Moreover, the connection part 1280 may include a spring action tab 1290, which serves as a mechanism to ensure that the connection part 1280 does not escape the tray slot in which it is inserted while allowing the connection part 1280 to be decoupled from the tray slot without a tool. To decouple the connection part 1280 from a tray slot without a tool, one simply depresses the spring action tab 1290 so that the connection part 1280 assumes a generally planar shape and then moves the connection part 1280 with depressed tab 1290 through the tray slot. In this manner, the drop cable tray 1200 can be readily decoupled from the enclosure base 1135 for reasons such as replacement of the drop cable 1200.

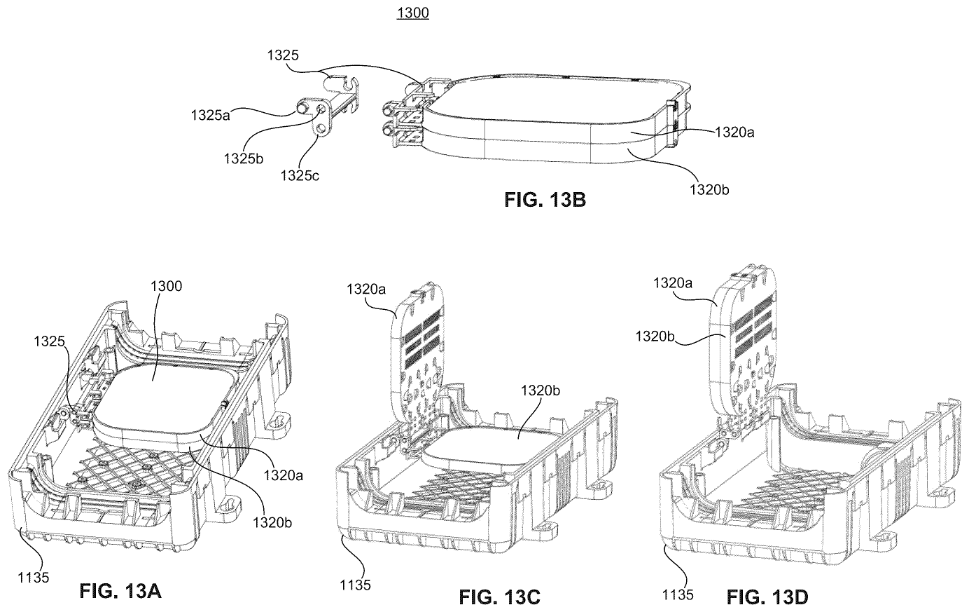

FIG. 13A is a perspective view of the enclosure base 1135 and a splice tray arrangement 1300 of the multi-cable terminal 1130 of FIGS. 11B-12C. The splice tray arrangement 1300 includes an upper splice tray 1320a, a lower splice tray 1320b, and a splice tray hinge 1325.

FIG. 13B is a perspective the splice tray arrangement 1300 the FIG. 13A configuration.

FIG. 13C is a perspective view of the FIG. 13A configuration, with the upper splice tray 1320a in a raised position.

FIG. 13D is a perspective view of the FIG. 13A configuration, with both the upper splice tray 1320a and the lower splice tray 1320b in raised positions.

As can be best seen from FIG. 13B, the splice tray hinge 1325 has a multiple pivot axis structure. That is, the splice tray hinge 1325 has a first axis 1325a, a second axis 1325b, and a third axis 1325c. As illustrated in FIGS. 13C and 13D, the first axis 1325a allows the splice tray hinge 1325 to rotate relative to the enclosure base 1135 when the splice tray hinge 1325 is installed in the enclosure base 1325; the second axis 1325b allows the upper splice tray 1320a to rotate relative to the splice tray hinge 1325 independent of the lower splice tray 1320b; and the third axis 1325c allows the lower splice tray 1320b to rotate relative to the splice tray hinge 1325 independent of the upper splice tray 1320a. The multiple pivot axis structure of the splice tray hinge 1325 allows the splice trays 1320a and 1320b to be stored deep inside the enclosure base 1135.

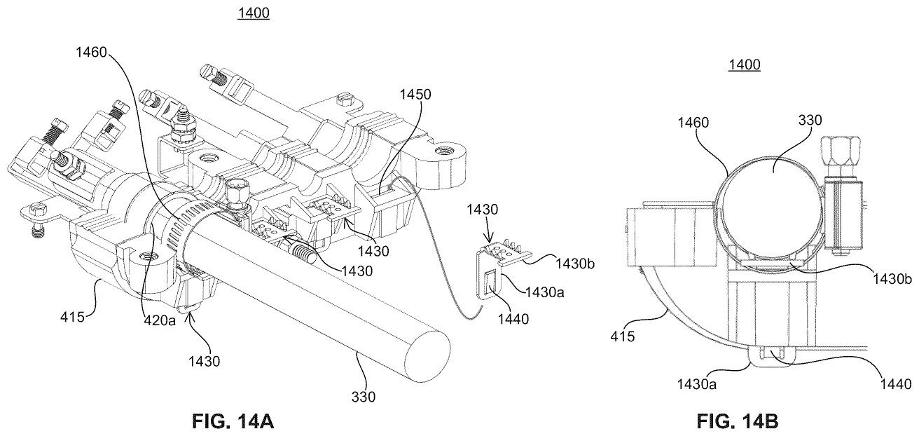

FIG. 14A is a perspective view of a feeder cable arrangement 1400 for the multi-cable terminal 1130 of FIGS. 11B-12C. The feeder cable arrangement 1400 may include the mating portion 415 of FIG. 4 and is shown with the input feeder cable 330 inserted in the main cable bore 420a. Other elements of the feeder cable arrangement 1400 include cable anchors 1430. Each cable anchor 1430 has an L-shaped design including a vertical portion, e.g., vertical portion 1430a, a horizontal portion, e.g., horizontal portion 1430b, and a catching structure on the vertical portion, e.g., catching structure 1440. Each cable anchor 1430 is movable in a direction perpendicular to the longitudinal axis of a cable to be secured by the cable anchor 1430, e.g., cable 330. Thereby, the cable anchors 1430 can accommodate different diameter cables while keeping the longitudinal axes of the cables at the same level. Also, with the L-shaped design and the catching structure 1440 on the vertical portion 1430a, the cable anchors 1430 can be secured in vertical slots of the mating portion 415, e.g., vertical slot 1450, after the cables are secured to the cable anchors 1430. For example, the cable 330 may be secured to a cable anchor 1430 with a hose clamp 1460 and then the cable anchor 1430 to which the cable 330 is attached may be inserted in a vertical slot 1450 of the mating portion 415.

FIG. 14B is a side view of the feeder cable arrangement 1400 of FIG. 14A. FIG. 14B shows how the hose clamp 1460 may secure the cable 330 to a horizontal portion 1430b of the cable anchor 1430 while a vertical portion 1430a of the cable anchor 1430 is secured within a vertical slot 1450 of the mating portion 415.

In addition, the following is noted in connection with FIGS. 11A-14B. Regarding FIGS. 11A-11C, the clamping levers 1105a and 1105b are removably and rotatably connected to the enclosure lid 1100, which allows the enclosure lid 1100 to be not only rotatable against the enclosure base 1135, but also linearly translatable up and down when it is closed (approaches the cable seal). Regarding FIGS. 12A-12D, the connection parts are made with elastic material and the drop cable tray 1200 is rotatable with the material's elasticity and the connection parts are also slidable to make the splice tray 1200 translatable up and down when it is to be stored. This motion gives a greater moving range for the splice tray 1200 and provides increased accessibility to lower trays. Also, attaching the cable seal to the splice tray 1200 facilitates proper sealing by ensuring proper positioning of the cable seal relative to the enclosure lid 1100 as the lid 1100 approaches the cable seal during closure of the multi-cable terminal 1130. The connection parts have a mechanism to be released from the drop cable tray 1200 so that the tray 1200 can be released from the connection parts without using a tool. Regarding FIGS. 13A-13D, the upper splice tray 1320a and the lower splice tray 1320b are stacked but are individually openable. Also, the multiple pivot axis structure of the splice tray hinge 1325 allows the splice trays 1320a and 1320b to be stored deep inside the enclosure base 1135. Regarding FIGS. 14A and 14B, each cable anchor is movable in a direction perpendicular the axis of the cable secured by the anchor. In this manner, the cable anchors can accommodate different diameter cables while keeping centers of the cables at the same height. And with the almost L-shape design and catching structure on the vertical portion, the cable anchors can be secured in vertical slots on the base part after the cable anchor is secured to the cable (e.g., with a hose clamp).

Embodiments of the present technology include, but are not restricted to, the following.

(1) A cable seal including a base; and an elastic material having a generally arched shape when the elastic material is not in a compressed configuration, and including a plurality of bores extending from a first side of the cable seal to a second side of the cable seal and a plurality of passages extending from the first side of the cable seal to the second side of the cable seal, the passages respectively corresponding to the bores such that for each bore a cable or plug may be inserted into the bore via the corresponding passage, wherein the base is configured to accommodate the elastic material, and wherein the elastic material is configured to be compressed against the base such that when each of the bores contains a cable or plug and the elastic material is compressed a watertight seal is formed between the elastic material and the base, a watertight seal is formed between the elastic material and each cable and/or plug, a watertight seal is formed between the elastic material and an enclosure in which the cable seal is positioned, and the passages are closed watertight.

(2) The cable seal according to (1), wherein when the elastic material is compressed the elastic material has a generally linear shape.

(3) The cable seal according to (1), wherein the base includes one or more grooves for accommodating respective main cables.

(4) A cable seal including a base having a plurality of base grooves extending from a first side of the cable seal to a second side of the cable seal, each base groove being shaped to accommodate a cable or plug; and a cover configured to mate with the base such that, when each base groove is accommodating a cable or plug and the cover is mated with the base a watertight seal is formed between the base and the cover, a watertight seal is formed between the base and each cable and/or plug, and a watertight seal is formed between the cover and each cable and/or plug.

(5) The cable seal according to (4), wherein the cover includes a plurality of cover grooves extending from the first side of the cable seal to the second side of the cable seal, and wherein the cover is configured to mate with the base such that the cover grooves align with respective ones of the base grooves.

(6) The cable seal according to (4), wherein the base has a first hardness, the cover has a second hardness, and the first hardness is equal to the second hardness.

(7) The cable seal according to (4), wherein the base has a first hardness, the cover has a second hardness, and the first hardness is greater than the second hardness.

(8) The cable seal according to (4), wherein the base having a base width dimension extending from the first side of the cable seal to the second side of the cable seal, the cover having a cover width dimension extending from the first side of the cable seal to the second side of the cable seal, and the base width dimension is smaller than the cover width dimension.

(9) The cable seal according to (4), wherein base includes a plurality of removable sections, the removable sections respectively corresponding to ones of the base grooves, and wherein for each base groove the removable section may be removed to increase a cross-sectional area of the base groove.

(10) The cable seal according to (9), wherein for each base groove removal of the removable section results in the base groove having an oval shaped cross-section.

(11) A cable seal including an elastic material having a plurality of bores extending from a first side of the cable seal to a second side of the cable seal and a plurality of passages extending from the first side of the cable seal to the second side of the cable seal, the passages respectively corresponding to the bores such that for each bore a cable or plug may be inserted into the bore via the corresponding passage, wherein each bore is configured to have a cross-sectional area that is larger than a cross-sectional area of the corresponding cable or plug when the elastic material is in an uncompressed state, and wherein the elastic material is configured to be compressed against an enclosure in which the cable seal is positioned such that when each bore contains a cable or plug and the elastic material is compressed a watertight seal is formed between the elastic material and each cable and/or plug, a watertight seal is formed between the elastic material and the enclosure, and the passages are closed watertight.

(12) The cable seal according to (11), wherein each bore has a circular cross-section, the cable or plug corresponding to the bore has a circular cross-section, and the diameter of the circular cross section for the bore is greater than the diameter of the cross-section for the cable or plug corresponding to the bore.

(13) The cable seal according to (11), wherein the cross-sectional area of at least one of the bores is different from the cross-sectional area of another one of the bores.

(14) The cable seal according to (11), wherein the elastic material includes a plurality of removable sections, the removable sections respectively corresponding to ones of the bores, and wherein for each bore the removable section may be removed to increase the cross-sectional area of the bore.

(15) The cable seal according to (14), wherein for each bore removal of the removable section results in the bore having an oval shaped cross-section.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A cable seal comprising:
a base; and
an elastic material having a generally arched shape when the elastic material is not in a compressed configuration, and including a plurality of bores extending from a first side of the cable seal to a second side of the cable seal and a plurality of passages extending from the first side of the cable seal to the second side of the cable seal, the passages respectively corresponding to the bores such that for each bore a cable or plug may be inserted into the bore via the corresponding passage,
wherein the base is configured to accommodate the elastic material, and
wherein the elastic material is configured to be compressed against the base such that when each of the bores contains a cable or plug and the elastic material is compressed a watertight seal is formed between the elastic material and the base, a watertight seal is formed between the elastic material and each cable and/or plug, a watertight seal is formed between the elastic material and an enclosure in which the cable seal is positioned, and the passages are closed watertight.

2. The cable seal according to claim 1, wherein when the elastic material is compressed the elastic material has a generally linear shape.

3. The cable seal according to claim 1, wherein the base includes one or more grooves for accommodating respective main cables.

4. A cable seal comprising:
a base having a plurality of base grooves extending from a first side of the cable seal to a second side of the cable seal, each base groove being shaped to accommodate a cable or plug; and
a cover configured to mate with the base such that, when each base groove is accommodating a cable or plug and the cover is mated with the base a watertight seal is formed between the base and the cover, a watertight seal is formed between the base and each cable and/or plug, and a watertight seal is formed between the cover and each cable and/or plug.

5. The cable seal according to claim 4, wherein the cover includes a plurality of cover grooves extending from the first side of the cable seal to the second side of the cable seal, and wherein the cover is configured to mate with the base such that the cover grooves align with respective ones of the base grooves.

6. The cable seal according to claim 4, wherein the base has a first hardness, the cover has a second hardness, and the first hardness is equal to the second hardness.

7. The cable seal according to claim 4, wherein the base has a first hardness, the cover has a second hardness, and the first hardness is greater than the second hardness.

8. The cable seal according to claim 4, wherein the base having a base width dimension extending from the first side of the cable seal to the second side of the cable seal, the cover having a cover width dimension extending from the first side of the cable seal to the second side of the cable seal, and the base width dimension is smaller than the cover width dimension.

9. The cable seal according to claim 4, wherein base comprises a plurality of removable sections, the removable sections respectively corresponding to ones of the base grooves, and wherein for each base groove the removable section may be removed to increase a cross-sectional area of the base groove.

10. The cable seal according to claim 9, wherein for each base groove removal of the removable section results in the base groove having an oval shaped cross-section.

11. A cable seal comprising
an elastic material having a plurality of bores extending from a first side of the cable seal to a second side of the cable seal and a plurality of passages extending from the first side of the cable seal to the second side of the cable seal, the passages respectively corresponding to the bores such that for each bore a cable or plug may be inserted into the bore via the corresponding passage,
wherein each bore is configured to have a cross-sectional area that is larger than a cross-sectional area of the corresponding cable or plug when the elastic material is in an uncompressed state, and
wherein the elastic material is configured to be compressed against an enclosure in which the cable seal is positioned such that when each bore contains a cable or plug and the elastic material is compressed a watertight seal is formed between the elastic material and each cable and/or plug, a watertight seal is formed between the elastic material and the enclosure, and the passages are closed watertight.

12. The cable seal according to claim 11, wherein each bore has a circular cross-section, the cable or plug corresponding to the bore has a circular cross-section, and the diameter of the circular cross section for the bore is greater than the diameter of the cross-section for the cable or plug corresponding to the bore.

13. The cable seal according to claim 11, wherein the cross-sectional area of at least one of the bores is different from the cross-sectional area of another one of the bores.

14. The cable seal according to claim 11, wherein the elastic material comprises a plurality of removable sections, the removable sections respectively corresponding to ones of the bores, and wherein for each bore the removable section may be removed to increase the cross-sectional area of the bore.

15. The cable seal according to claim 14, wherein for each bore removal of the removable section results in the bore having an oval shaped cross-section.
